(19) United States
(12) Patent Application Publication
(10) Pub. No.: US 2010/0271900 A1
(43) Pub. Date: Oct. 28, 2010

(54) MIXER COMPRISING MIXING TOOLS WHICH ARE DRIVEN BY THE ROTATION OF THE BOWL

(76) Inventors: Gerard Fisson, de Grand Lieu (FR); Pascal Ricard, Treize Septiers (FR); Laurent Jaunet, de Grand Lieu (FR); Guillaume Vannier, Nantes (FR)

Correspondence Address: CANTOR COLBURN, LLP, 20 Church Street, 22nd Floor, Hartford, CT, 06103, US

(21) Appl. No.: 11/815,795

(22) PCT Filed: Feb. 15, 2006
(86) PCT No.: PCT/FR2006/000351

§ 371 Date: Mar. 25, 2010

(30) Foreign Application Priority Data
Feb. 15, 2005 (FR) 0501516
Apr. 5, 2005 (FR) 0503361

(51) Int. Cl. A21C 1/14; A21C 1/00

(52) U.S. Cl. 366/76.9; 366/94; 366/76.1

(57) ABSTRACT

The invention relates to a mixer comprising tools (6a, 6b) and a frame which supports (i) a bowl (5) for the material to be mixed and (ii) motorization means (4, 8) for rotating the mixing tools (6a, 6b). According to the invention, each mixing tool (6a, 6b) comprises a shaft which is mounted to the base of the bowl (5) such that it can rotate and which co-operates with the motorization means (4, 8) in order to rotate the mixing tools (6a, 6b).

The invention relates to a mixer, in particular a kneader, equipped with several mixing tools, as well as a system comprising such a mixer.

Such mixers can be used in all areas of industrial mixing such as, for example, the production of dough for bakeries or for mixing powders, meats or salads.

To ensure the dough, in particular bakery dough, is well kneaded, the kneaders must be arranged to subject the dough to a succession of cuts and stretches inside the bowl.

Three types of mixers designed for these applications are known in the prior art
oblique axis kneaders, comprising a turning revolving bowl and rotating mixing tools (with an oblique axis) inserted in the bowl;
spiral kneaders, also comprising a turning revolving bowl and rotating mixing tools inserted in the bowl;
whisks, comprising a fixed bowl and rotating mixing tools inserted in the bowl, the axis of rotation of which describes a circle inside the bowl.

The main drawbacks of these mixers of the prior art relate to the presence of tools inserted in the bowl from above, making it difficult to access the bowl when loading or unloading the material to be mixed.

Some of these mixers have heads bearing tools which can be raised, thus separating the tool from the bowl but not offering completely unimpeded access.

Furthermore, the configurations with inserted tools and turning bowl of the oblique axis kneaders and spiral kneaders does not allow the bowl to be sealed during the mixing process, thus making it impossible to perform airless or pressurised mixes.

On the other hand, the mechanical parts providing the transmission and rotation of the whisk-type mixer tools are complex and expensive to manufacture.

The aim of the invention is to overcome these drawbacks of the prior art, while providing a succession of stretches/cuts of the dough that is optimal for kneading food dough based on flour and water.

For this purpose, the invention firstly relates to a mixer comprising at least two mixing tools, a frame supporting, on the one hand, a bowl containing the material to be mixed and, on the other hand, motorisation means for driving the rotation of the mixing tools, characterised in that each mixing tool comprises a shaft rotatingly mounted to the bottom of the bowl, which cooperates with the motorisation means causing the rotation of said mixing tools.

As the mixing tools are fixed to the bottom of the bowl, the top of the latter is entirely free for the loading and unloading operations as well as for adding ingredients during the preparation.

According to one embodiment, the motorisation means also drive the rotation of the bowl and the bottom of the bowl is solidly attached to a shaft connected to the motorisation means for driving the rotation of the bowl, in order for the rotation of the bowl to cause the rotation of said mixing tools.

The principle of driving the tools by the rotation of the bowl allows the use of a single set of motorisation means associated with a very simple and compact transmission, thus resulting in a simple and reliable machine with a much lower manufacturing cost than the embodiments of the prior art.

In the same way, as the frame does not have to fulfil complex functions to support the various motorisation means, the bowl and the tools, it is reduced to a simple support for the bowl—motorisation means—transmission assembly.

The bowl, designed to turn on its axis while mixing, is preferably a volume of revolution, for example a cylinder, but it can also take other shapes, for example substantially oblong.

One embodiment in which the bowl is substantially oblong improves the cutting and removal of the dough.

According to one embodiment, the motorisation means of the mixer comprise a geared motor connected to the shaft solidly attached to the bowl and a crown gear which said shaft passes through, which is free in relation to said shaft and solidly attached to the geared motor, characterised in that each shaft of the mixing tools has one pinion in direct contact with said crown gear.

The crown gear can be equipped with outer gear teeth, the pinions borne by the shafts of the mixing tools engaging with the outer perimeter of the crown gear or, as a variation, it can be equipped with inner gear teeth, the pinions then engaging with the inner perimeter of the crown gear.

As a variation of this embodiment, said pinions and said crown gear are located substantially in the same plane and, rather than being in direct contact, are in contact by means of synchronous transmission means, such as a synchronous belt or a chain. In this case, the crown gear has as many levels of gear teeth as there are pinions to be driven, and a chain or belt connects each pinion to the corresponding toothed level of the gear.

In order to improve the efficiency of the mixing stage, another embodiment is possible in which the mixing bowl is mounted on a tilting device which makes it possible to form an angle α between the axis of rotation of the bowl and the vertical.

This arrangement has the advantage of allowing the bowl to be tilted while mixing so as to use the force of gravity to improve the circulation of the material to be mixed in the bowl.

The ability of the mixer to tilt can also be used to make it easier to load and unload the material.

From this perspective, the frame can comprise, in its parts in contact with the ground, openings designed to cooperate with the forks of a fork-lift truck so as to move the mixer to an unloading area, possibly at height, and to unload it by tilting the bowl.

It is also possible to equip the mixer with additional features for particular mixtures.

The mixing bowl can, for example, comprise a removable cover enabling mixing in a closed enclosure for safety reasons.

Furthermore, when in the closed position, such a cover can be arranged to form a sealed enclosure with the bowl, comprising a device for injecting or pumping gas designed to create a controlled mixing or kneading atmosphere in said sealed enclosure. In particular, according to the required kneading method, kneading can be performed in a partial vacuum or under pressure from neutral gas or oxygen-enriched gas.

In the same way, the mixing bowl can comprise, set into its walls, a device for circulating cooling or heating liquids to allow mixes to be made at a controlled temperature.

More specifically, the invention relates to a kneader for a food dough based on water and flour, in which the mixing tools are kneading tools.

The invention further relates to a system comprising a mixer as previously described as well as a device for unloading the mixed material.

Such a system comprises a mixer with a tilting bowl, a hopper and a conveyor system for the mixed material, these three elements being arranged so that, at the end of the mixing process, the tilting of the bowl causes the mixed material to fall into the hopper, the latter guiding the mixed material towards the conveyor system.

In one embodiment of the system, the mixer is mounted on an integrated elevator allowing the mixed material to be poured into a hopper at height.

Other special features and advantages of the invention will become apparent from the following description made in reference to the appended drawings, given as non-limiting examples:

FIG. 1 is a side view of a mixer according to the invention, the bowl, the motorisation means and the transmission means being cross-section views:

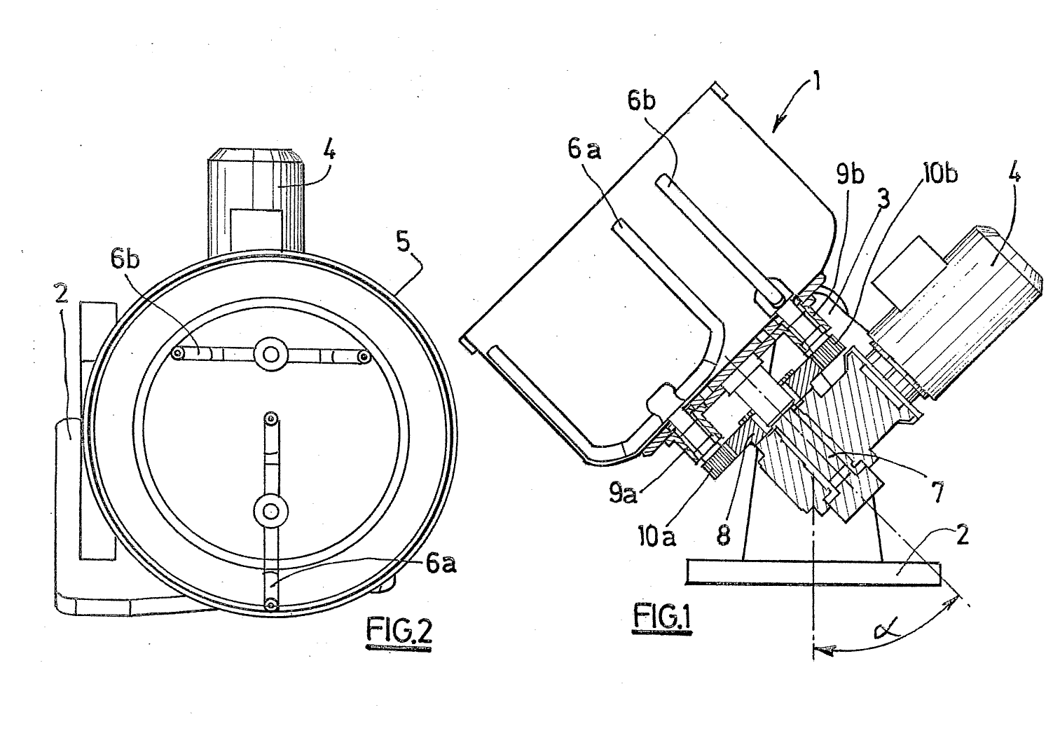

FIG. 2 is a top view of the mixer of FIG. 1

FIG. 3 is a perspective view of the mixer of FIG. 1;

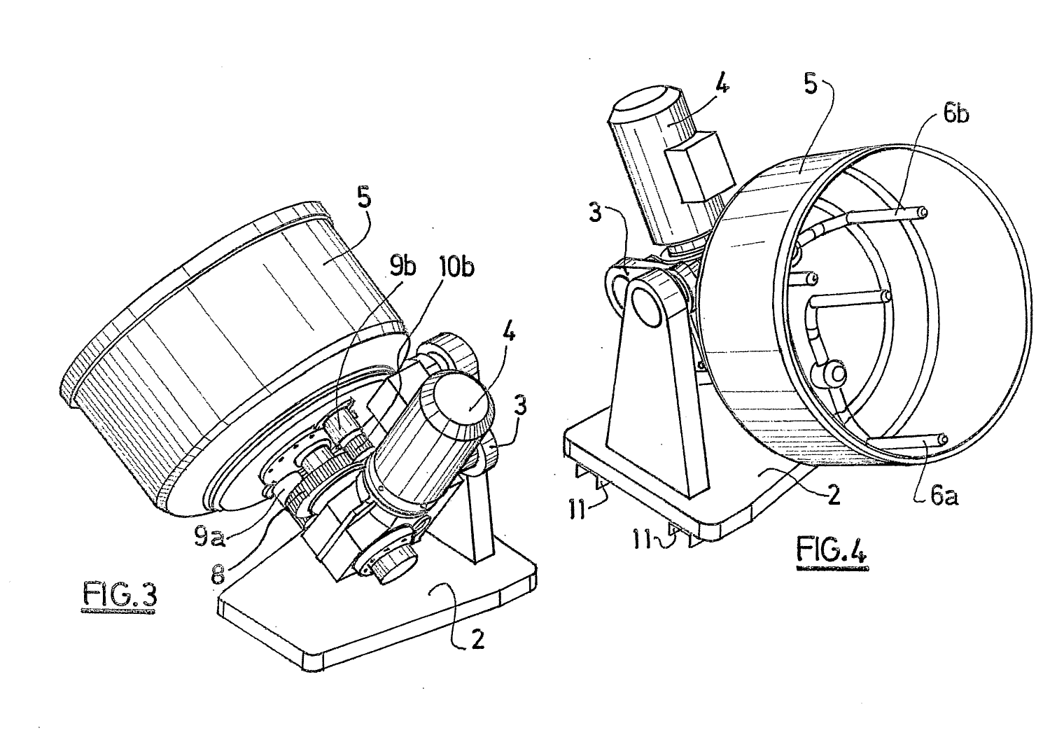

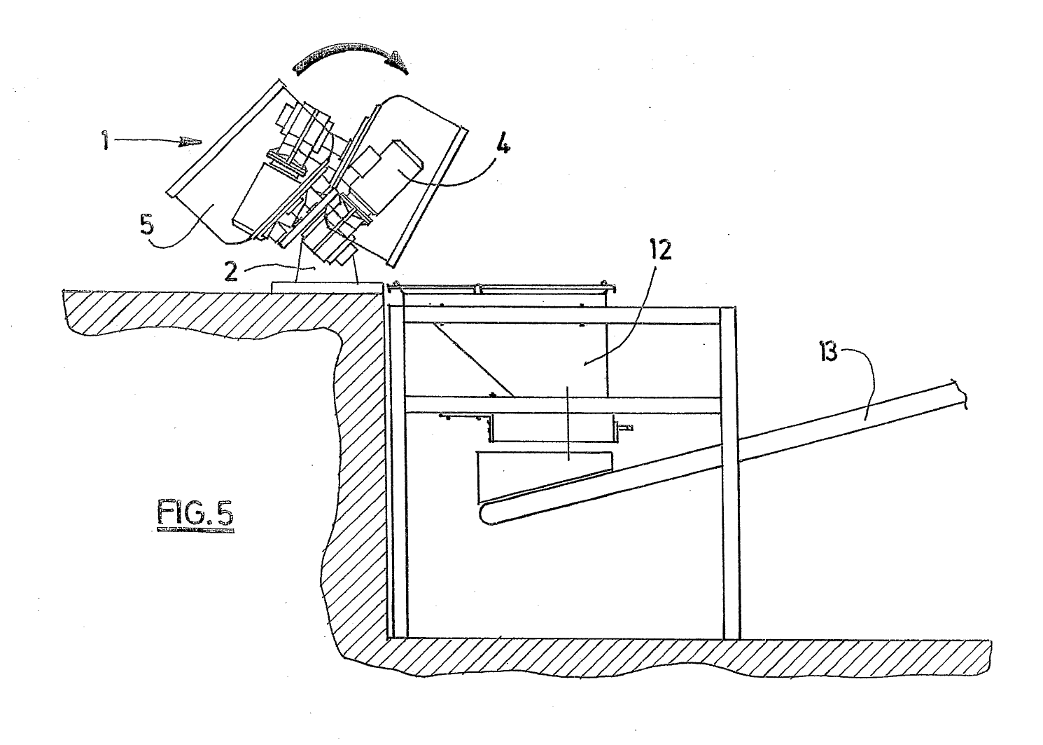

FIG. 4 is a perspective view of a mixer according to another embodiment of the invention.

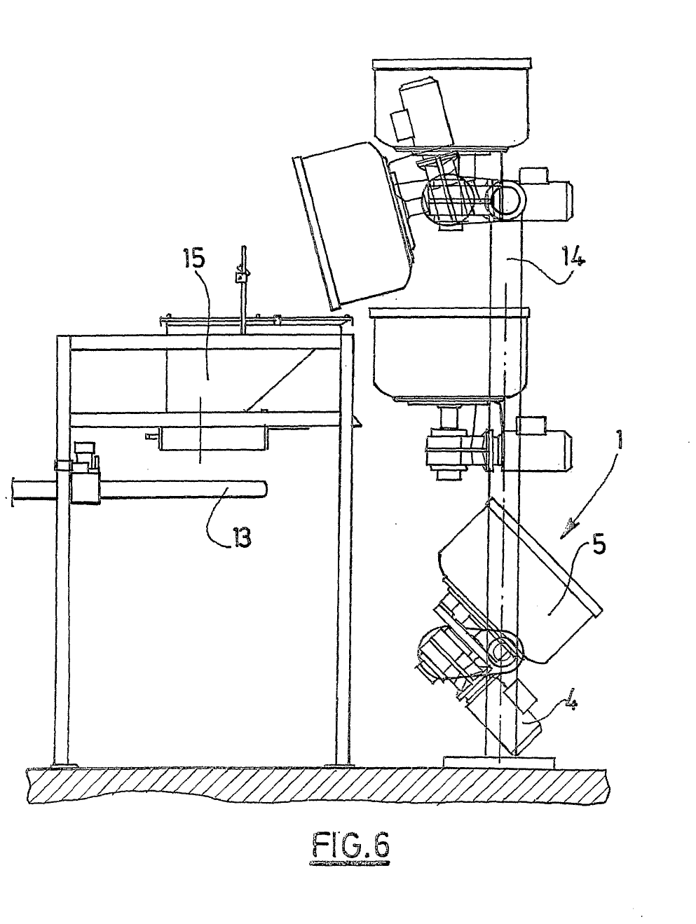

FIG. 5 shows a system according to the invention;

FIG. 6 shows a system according to another embodiment of the invention;

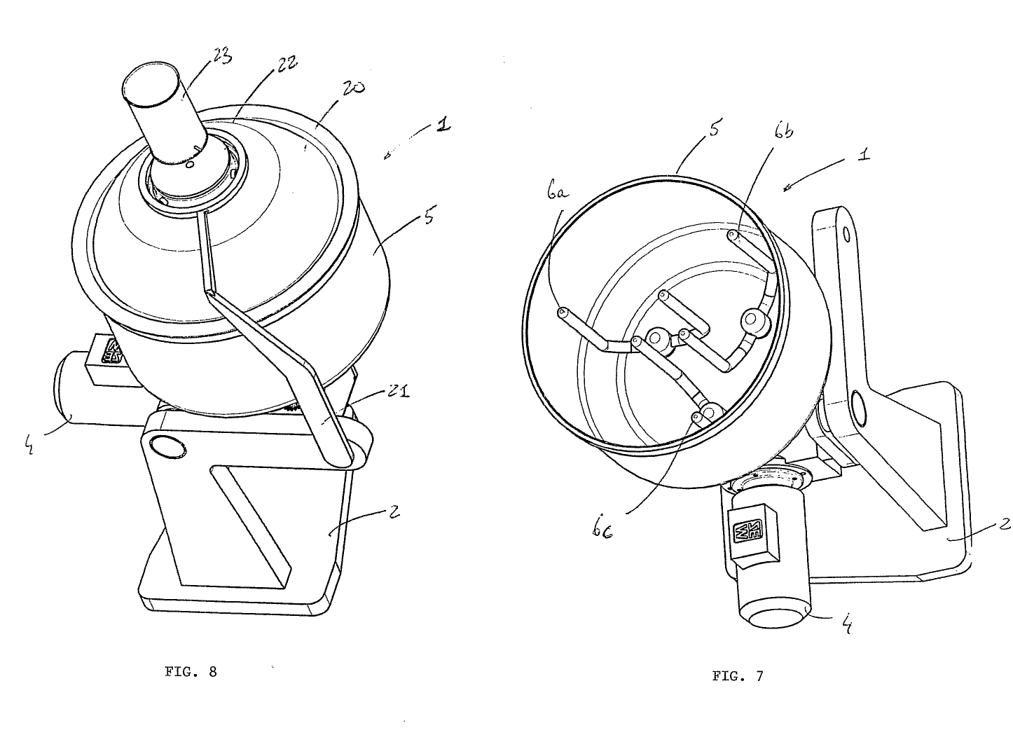

FIG. 7 is a perspective view of a three-tool kneader according to the invention;

FIG. 8 is a side view of a variation of the embodiments of FIGS. 1 to 7 in which the bowl is equipped with a cover.

The mixer 1 shown in FIGS. 1 to 8 is made up of a frame 2 forming a base with a pivoting link according to a horizontal axis with the support 3 of a geared motor 4.

A bowl 5, designed to contain the material to be mixed, and rotating mixing tools 6a, 6b form an assembly supported by the geared motor 4.

More specifically, the geared motor 4 comprises an output shaft 7 with a plate on which the mixing bowl 5 is fixed so that the rotation of said shaft 7 drives the rotation of the bowl 5 in its axial direction.

A crown gear 8 is fixed to the body of the geared motor 4, between the geared motor 4 and the bottom of the bowl 5 and surrounding the output shaft 7 of the geared motor 4, the axial direction of the toothed wheel 8 matching the axis of rotation of the bowl 5 and the output shaft 7 of the geared motor.

The two mixing tools 6a, 6b, mounted on either side of the axis of rotation of the bowl 5 each consists of two arms welded to a shaft mounted so as to turn in a sealed bearing 9a, 9b solidly attached to the bottom of the bowl 5. Each of these shafts starts at the outer wall of the bottom of the bowl 5, on the geared motor side 4, and comprises a pinion 10a, 10b engaging with the crown gear 8 fixed to this end.

The arms of each of these tools are placed in planes perpendicular to one another and said tools pass through overlapping volumes.

In the embodiment of FIG. 7, the mixer, which is a kneader, comprises three mixing tools, or kneading tools, 6a-6c, positioned at an angle of 120° to each other around the axis of rotation of the bowl. These tools pass through overlapping volumes.

In the two embodiments described, each mixing tool is arranged so as to pass through a volume contained within a line which, on the one hand, is tangential to the inner periphery of the bowl and, on the other hand, extends near the centre of the bowl.

Thus, during the rotation of the tools, the kneader according to the invention provides a dough-cutting area near the centre of the bowl and dough-stretching areas between the inner periphery of the bowl and each tool. In particular, with two tools, the cutting area is doubled as it is formed by two arms of each tool, turning in opposite directions, while with three tools, the cutting area is tripled. As regards the stretching areas, they are formed in a particularly efficient manner due to the combined rotation of the bowl and the tools.

These embodiments make it possible to obtain a succession of cuts and stretches of the dough, which is beneficial for proper kneading of a food dough based on flour and water.

In other embodiments, a different number of tools, or differently shaped tools, can be provided so as to modify the nature or the number of the dough stretching/cutting areas.

According to a variation of the embodiments of the kneader according to the invention, a removable cover 20 can be provided for the bowl. According to FIG. 8, the cover 20 is mounted on the bowl 5 by means of an arm 21 hinging on the frame 2 so as to be able to seal the bowl 5 hermetically. In particular, a joint can be provided at the point of contact between the bowl 5 and the cover 20.

Furthermore, the cover comprises a secure trap 22 for inserting the ingredients of the dough to be kneaded, which reduces the contact between the operator and the dust from said ingredients when they are inserted in the bowl. FIG. 8 also shows a swivel joint 23 arranged to be associated with the trap 22 so as to allow pumping or injection of gas.

The bowl—mixing tools—motorisation means—transmission means assembly is thus borne by the support 3 of the geared motor 4 and can tilt in relation to the frame 2.

The mixer 1 which has just been described works in the manner described below.

The bowl 5 is rotated by a geared motor 4. This rotational movement of the bowl 5 causes the axles of the mixing tools 6a, 6b to describe a circular trajectory around the axis of rotation of the bowl 5, causing the pinions 10a, 10b to roll on the fixed crown gear 8, thus causing the rotation of the tools 6a, 6b.

According to one embodiment, the bowl can be fixed and only the mixing tools 6a and 6b are driven in rotation by the motorisation means.

The general design of the mixer is such that the assembly comprising the bowl 5, the geared motor 4 and the transmission means is pivotingly linked to the base 2 and allows the bowl 5 to be tilted so that the axis of rotation of the bowl 5 forms an angle α with the vertical (see FIG. 1).

It is therefore possible to form an angle α during the mixing process, which improves the efficiency of the mix in terms of dead zones, which is to say volumes of the bowl 5 through which the tools 6a, 6b do not pass, and where the mixed material has a tendency to stagnate.

With an appropriate tilting angle during the mixing stage, the material in the dead zones falls, due to the action of gravity, into the volumes which the tools pass through.

It is also possible to use the tilting capabilities of the bowl 5, after the mixing stage, to unload the mixed material.

A very simple unloading process is possible by equipping the mixer with openings 11 for fork-lift truck forks and bringing the mixer, at the time of unloading, to the desired location and height and then tilting the bowl sharply so as to empty it. FIG. 4 shows an example of such a mixer.

Systems allowing the product to be unloaded are also shown in FIGS. 5 and 6.

In FIG. 5 this consists of a mixer fixed at floor height, unloading into a hopper 12 underneath it.

FIG. 6 shows a mixer fixed to a lifting column 14 and unloading into a hopper 15 at height.

The machine described above has the following particular advantages:
allowing full access to the bowl 5 for the unloading or unloading stages;
having a simple and robust, and therefore reliable, mechanism;
being cheaper to produce than equivalent machines thanks to the reduction in the number and complexity of the moving parts;
allowing kneading under a controlled atmosphere;
limiting contact between the operator and the dust from the ingredients of the dough to be kneaded;
providing modular cutting and stretching areas for the dough which have kinematics suitable for optimal kneading of a food dough based on flour and water.

We claim:

1. A mixer comprising:
at least two mixing tools;
and a frame supporting,
a bowl for containing material to be mixed, and
motorization means for rotating the mixing tools;
wherein each mixing tool comprises a mixing tool shaft rotatingly mounted to a bottom of the bowl and which co-operates with the motorization means causing the rotation of the mixing tools.

2. The mixer of claim 1, wherein the motorization means also rotate the bowl, the bottom of the bowl being solidly attached to an output shaft connected to the motorization means for driving the rotation of the bowl, such that the rotation of the bowl causes the rotation of the mixing tools.

3. The mixer of claim 2,
wherein the motorization means comprise a geared motor connected to the output shaft and solidly attached to the bowl, a crown gear, through which the output shaft passes, and which is free in relation to the output shaft and solidly attached to the geared motor; and
wherein each mixing tool shaft has a pinion in direct contact with the crown gear.

4. The mixer of claim 3,
wherein the crown gear is equipped with outer gear teeth; and
wherein, the pinions engage with the outer gear teeth of the crown gear.

5. The mixer of claim 3,
wherein the crown gear is equipped with inner gear teeth; and
wherein, the pinions engage with the inner gear teeth of the crown gear.

6. The mixer of claim 2, wherein the motorization means comprise
a geared motor connected to the output shaft
a crown gear through which the output shaft passes, the crown gear being is free in relation to the output shaft and solidly attached to the geared motor,
wherein each mixing tool shaft has a pinion, and
wherein the pinions and the crown gear are located substantially in the same plane and are connected together via synchronous transmission means.

7. The mixer of claim 1, wherein each mixing tool is arranged so as to pass through a a line which is tangential to the inner periphery of the bowl and extends toward the center of the bowl.

8. The mixer of claim 1, wherein arms of each mixing tool are located in planes perpendicular to one another, such that the mixing tools pass through overlapping volumes.

9. The mixer of claim 1, wherein arms of each mixing tool are located in planes positioned at an angle of 120° to each other around an axis of rotation of the bowl, such that the mixing tools pass through overlapping volumes.

10. The mixer of claim 1, wherein the mixing bowl is substantially cylindrical.

11. The mixer of claim 1, wherein the mixing bowl is substantially oblong.

12. The mixer of claim 1, wherein the bowl is mounted on a tilting device making it possible to form an angle α between an axis of rotation of the bowl and vertical.

13. The mixer of claim 12, wherein the bowl and the motorization means form an assembly connected to the frame by a pivoting link.

14. The mixer of claim 1, wherein the bowl comprises a removable cover.

15. The mixer of claim 14, wherein the cover comprises a trap for inserting ingredients of dough to be mixed.

16. The mixer of claim 14, wherein the cover in closed position forms a sealed enclosure with the bowl, comprising a gas pumping or injection device designed to create a controlled mixing atmosphere in the sealed enclosure.

17. The mixer of claim 1, wherein the bowl comprises, set into its walls, a device for circulating heating or cooling fluids.

18. The mixer of claim 1, wherein the frame comprises, openings designed to cooperate with the forks of a fork-lift truck, wherein the openings are in contact with the ground.

19. The mixer of claim 1, wherein the mixer is a kneader, and the mixing tools are kneading tools.

20. An industrial mixing system, comprising:
a mixer comprising:
at least two mixing tools;
and a frame supporting a bowl for containing material to be mixed, and motorization means for rotating the mixing tools;
wherein each mixing tool comprises a mixing tool shaft rotatingly mounted to a bottom of the bowl and which co-operates with the motorization means causing the rotation of the mixing tools; and
wherein the bowl is mounted on a tilting device making it possible to form an angle α between an axis of rotation of the bowl and vertical;
a hopper; and
a conveyor system for the mixed material;
wherein the mixer, the hopper, and the conveyor system are, arranged so that, at the end of the mixing process, tilting of the mixer bowl causes mixed material to fall into the hopper, the hopper guiding the material towards the conveyor system.

21. The industrial mixing system of claim 20, wherein the mixer is mounted on an integrated elevator allowing the mixed material to be poured into the hopper at height.
